(19) United States
(12) Patent Application Publication
(10) Pub. No.: US 2015/0345290 A1
(43) Pub. Date: Dec. 3, 2015

(54) SURFACE MINING TOOTH RETENTION

(71) Applicant: Edward Lee CUTLER, Bloomfield, IA (US)

(72) Inventor: Edward Lee CUTLER, Bloomfield, IA (US)

(21) Appl. No.: 14/759,054

(22) PCT Filed: Dec. 20, 2013
(86) PCT No.: PCT/US13/76949

§ 371 Date: Jul. 2, 2015

Related U.S. Application Data
(60) Provisional application No. 61/748,388, filed on Jan. 2, 2013.

(51) Int. Cl. E21C 35/19; E21C 25/00; F16B 2/22; E21C 25/10

(52) U.S. Cl. CPC E21C 35/19; E21C 25/10; E21C 25/00; F16B 2/22

(57) ABSTRACT

A reducing element retention clip is disclosed herein. The reducing element retention clip includes a handle and two flexible legs extending from the handle. The two flexible legs are configured to flex apart to receive a shaft of the reducing element. The handle aligns along a first plane and the two flexible legs align along a second plane. The first and second planes are angled relative to one another.

### CROSS REFERENCE TO RELATED APPLICATIONS

This application is being filed on 20 Dec. 2013, as a PCT International patent application, and claims priority to U.S. Provisional Patent Application No. 61/748,388, filed Jan. 2, 2013, the disclosure of which is hereby incorporated by reference herein in its entirety.

### TECHNICAL FIELD

The disclosure relates to a reducing element retention clip for mounting reducing elements.

### BACKGROUND

Relatively hard materials are often processed for mining and construction. The variety of materials includes rock, concrete, asphalt, coal, and a variety of other types of earth formations. A number of different methods for reducing the size of these hard materials have been developed. One traditional material size reduction method has been to drill relatively small holes in the material which are then packed with an explosive that is ignited resulting in a rapid and cost effective method of size reduction. However, there are a variety of disadvantages to this technique including the inherent risk of injuries, the production of undesirable noise, vibrations, and dust, and the fact that this process is difficult to utilize in situations where space is limited or where there is a potential risk of causing other gases to ignite.

Due to the above-described disadvantages associated with blasting techniques, alternative methods have been developed for reducing relatively hard materials. One alternative has been the use of reducing machines having rotary reducing components that move rigid and specialized reducing elements through paths of travel. The reducing components can include rotating drums that move the reducing elements through circular paths of travel. Such drums are typically attached to corresponding machines so that the positions and orientations of the drum can be controlled to bring the reducing elements into contact with the material being reduced. Alternative reducing components can include boom-mounted chains that carry reducing elements. The chains are typically driven/rotated about their corresponding booms. The reducing elements are mounted to and move along the paths of travel defined by the chains. In use, the booms are moved (e. g., through a pivoting motion) to positions where the reducing elements are brought into contact with the material being reduced.

An example machine of the type described above is disclosed at U.S. Pat. No. 7,290,360. The disclosed machine is a surface excavation machine used for applications such as surface mining, demolishing roads, terrain leveling, and prepping sites for new construction or reconstruction by removing one or more layers of material. Surface excavation machines of this type provide an economical alternative to blasting and hammering and provide the advantage of generating a consistent output material after a single pass. This can reduce the need for primary crushers, large loaders, large haul trucks and the associated permits to transport materials to crushers.

Installation and removal of reducing elements often requires the use of tools, such as hammers, screwdrivers, pliers, or even a battery powered press. These tools can either be used to force the reducing element out of its holder or to install a new reducing element. There are several disadvantages when changing a reducing element as described above. One disadvantage is that installation and/or removal using tools can be slow and cumbersome. Another disadvantage is the risk of injury presented when using tools.

As a result of these issues, there are significant benefits to a new process of installing, removing, and/or replacing reducing elements where no tools are required.

### SUMMARY

In general terms, this disclosure is directed to an apparatus including a reducing element having a shaft and a circumferential groove, a holder that receives the shaft of the reducing element, a reducing element retention clip that mounts at the circumferential groove to retain the reducing element within the holder. The reducing element retention clip includes a handle, two flexible legs extending from the handle; the two flexible legs are configured to flex apart to receive the shaft of the reducing element. The handle aligns along a first plane and the two flexible legs align along a second plane such that the first and second planes are angled relative to one another.

Another aspect of the disclosure includes a reducing element retention clip. In one possible configuration, the reducing element retention clip includes a handle and two flexible legs extending from the handle. The two flexible legs can be configured to flex apart to receive a shaft of the reducing element. The handle can align along a first plane and the two flexible legs can align along a second plane. The first and second planes can be angled relative to one another.

Another aspect of the disclosure includes a reducing element retention clip including a flexible clip-defining member shaped to form a handle and a pair of legs that extend from the handle. The handle has a flat end and a width of at least 1.25 inches. The pair of legs is integral with the handle and configured to flex apart to receive a shaft of the reducing element between the legs.

A further aspect of the disclosure includes a reducing element retention clip including a handle. The handle has a finger loop that defines an opening having a width of at least 1.25 inches. The reducing element retention clip further includes a pair of legs extending from the handle. The pair of legs defines a tapered lead-in portion. A shaft retention portion is positioned between the handle and the tapered lead-in portion. The shaft retention portion includes a shaft retention area positioned between two restrictions defined by the clip. The first restriction is located between the tapered lead-in portion and the shaft retention area and the second restriction is located between the shaft retention area and the handle.

Still another aspect of the disclosure includes an excavating machine including a cutting tool and reducing elements releasably secured to the cutting tool by reducing element retention clips.

### BRIEF DESCRIPTION OF THE DRAWINGS

FIG. 1 is a side view of a surface excavation machine incorporating reducing elements in accordance with the principles of the present disclosure;

FIG. 2 is a reducing element that can be used with the machine of FIG. 1;

FIG. 3 is a perspective view of a mounting structure including the reducing element of FIG. 2;

FIG. 4 is a perspective view of a reducing element retention clip in accordance with the principles of the present disclosure;

FIG. 5 is a plan view of the reducing element retention clip of FIG. 4;

FIG. 6 is a side view of the reducing element retention clip of FIG. 4; and

FIG. 7 is a top view of the reducing element retention clip of FIG. 4.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the inventive aspect disclosed herein.

The present disclosure relates generally to a method of mounting reducing elements to a material reducing machine using a reducing element retention clip. In one example, the material reducing machine includes a rotary component such as a drum or chain that carries the reducing elements. The reducing elements can be mounted to the drum without the use of tools, thereby reducing the time required to change the reducing elements. The tool free method also improves overall safety for the operators changing the reducing elements. A new reducing element retention clip is designed to retain the reducing element in place and to allow for easy replacement of the reducing element by hand.

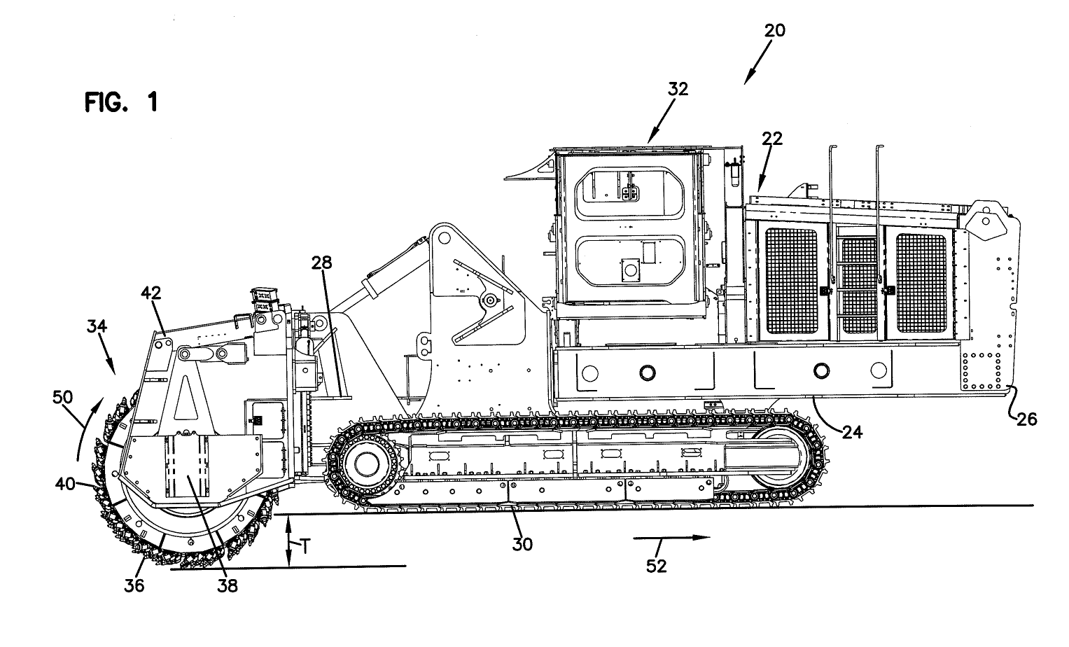

FIG. 1 illustrates a surface excavation machine 20 that includes a tractor 22 having a main chassis 24 (i.e., a mainframe) including a front end 26 and a rear end 28. The main chassis 24 is supported on a ground drive system (i.e., a propulsion system) that can include multiple propulsion structures such as wheels or tracks 30 for propelling the machine 20 over the ground. An operator cab 32 is positioned at a top side of the main chassis 24. An excavation tool 34 is mounted at the rear end 28 of the main chassis 24. The excavation tool 34 includes an excavation drum 36 that is rotatably driven (e.g., by hydraulic motors) about a drum axis 38. The excavation drum 36 carries a multiple reducing elements 40 suitable for cutting rock. The excavation drum 36 can be mounted to a boom that can be pivoted between a lowered excavation position (see FIG. 1) and a raised transport position (not shown). A shroud 42 at least partially surrounds/encloses the excavation drum 36.

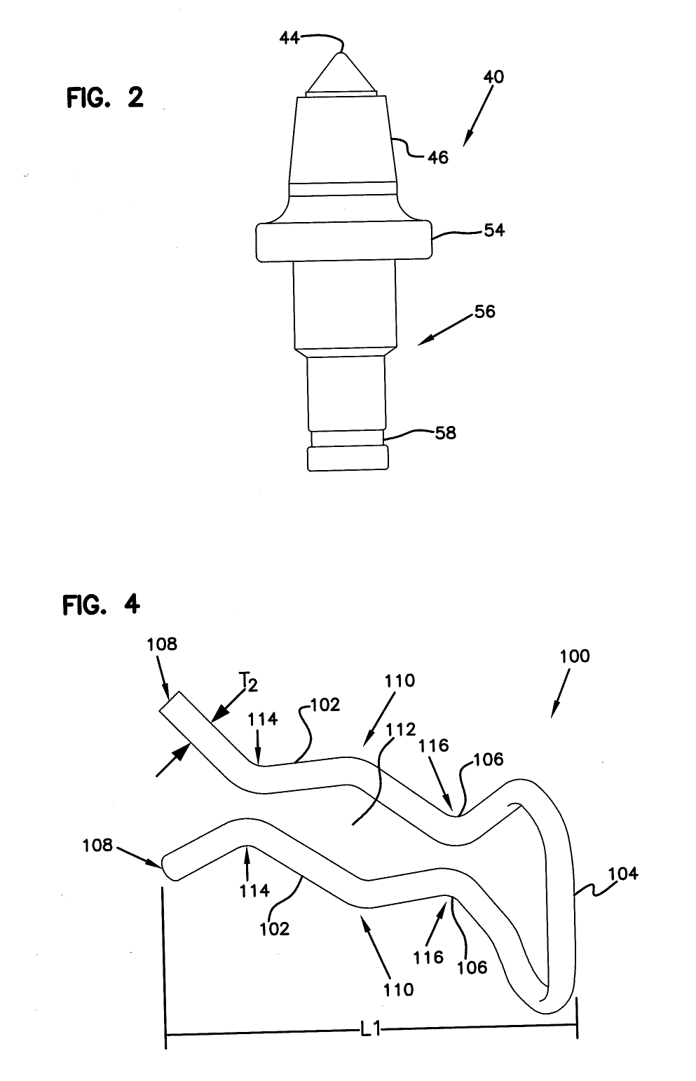

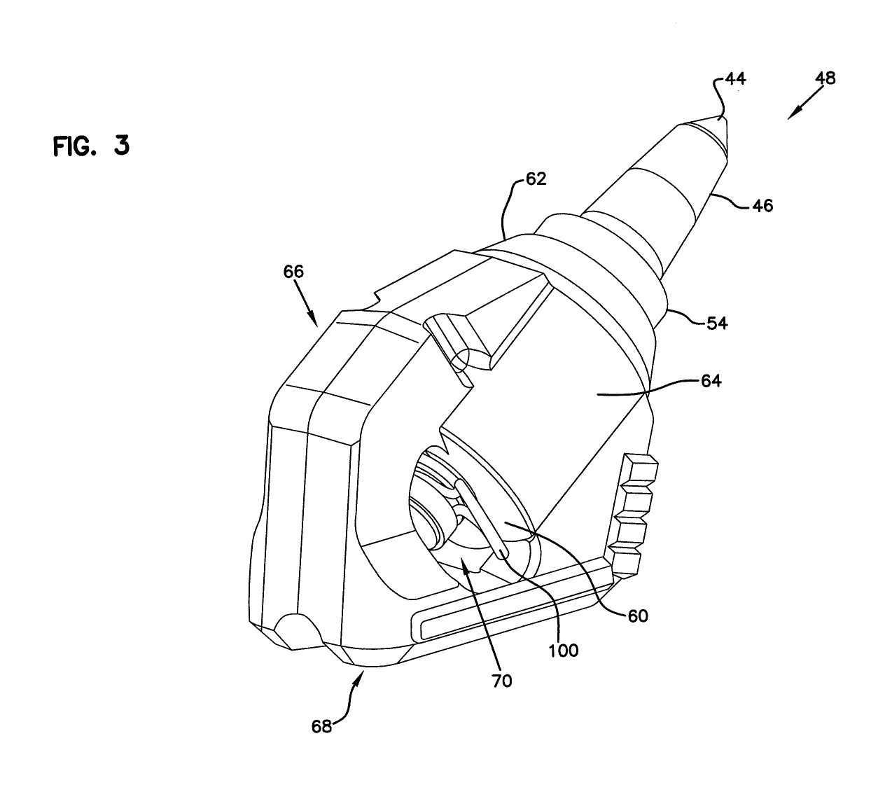

As shown at FIG. 2, the reducing element 40 is depicted as a tooth having a leading tip 44 supported on a base 46. In other embodiments, the reducing element 40 may include a cutter, a pick, a chisel, a blade, or other type of device. In certain examples, the leading tip 44 can be harder than the base 46. For example, leading tip 44 can be a solid, carbide insert while the base 46 can be hardened steel. In certain examples, the reducing elements 40 are removably mounted to the excavation drum 36. For example, the reducing elements 40 can be fastened within mounting structures such as a holder 48 (FIG. 3) integrated with or coupled to the excavation drum 36. The holder 48 is illustrated and described in more detail with reference to FIG. 3.

In use of the surface excavation machine 20, the surface excavation machine 20 is moved to an excavation site while the excavation tool 34 is in the transport position. When it is desired to excavate at the excavation site, the excavation tool 34 is lowered from the transport position to the excavation position (see FIG. 1). While in the excavation position, the excavation drum 36 is rotated in a direction 50 about the axis 38 such that the excavation drum 36 uses a down-cut motion to remove a desired thickness T of material (FIG. 1). During the excavation process, the tracks 30 propel the surface excavation machine 20 in the forward direction 52, thereby causing a top layer of material having a thickness T to be excavated. As the excavation machine 20 moves in a forward direction 52, the reducing elements 40 dig into the material under the excavation drum 36, leaving behind excavated material. Example excavation applications for which the surface excavation machine 20 can be used include surface mining, road milling, terrain leveling, construction preparation and other activities. In other examples, the drum 36 can be configured to excavate using an up-cut motion.

Referring again to FIG. 2, the reducing element 40 further includes a shoulder 54, a shaft 56, and a circumferential groove 58. The shoulder 54 extends radially outwardly from the base 46 and has a cross-dimension larger than a maximum cross-dimension of the base 46. The shaft 56 extends axially from the shoulder 54 of the reducing element 40 and has a narrower cross-dimension than that of the shoulder 54. The shaft 56 of the reducing element 40 may further include an inwardly tapered section along the shaft 56. The reducing elements 40 are constructed to fit into mounting structures (e.g., see holder 48) that are integrated with or otherwise coupled to drums or chains used to carry the reducing element 40 during material reducing applications. The holders 48 can be secured to the drum 36 or chain by various attachment processes, such as, but not limited to, welding. The reducing element 40 is designed to be readily replaceable, while the holder 48 is not intended to be replaced frequently.

Referring to FIG. 3, the holder 48 has a holding sleeve 64 having an inner end 60 and an outer end 62. The holding sleeve 64 is configured to receive the shaft 56 of the reducing element 40. The shaft 56 of the reducing element 40 goes through the holding sleeve 64 of the holder 48 and extends beyond the inner end 60 such that the circumferential groove 58 of the reducing element 40 is accessible. The shoulder 54 of the reducing element 40 abuts against the outer end 62 of the holding sleeve 64 when the reducing element 40 is mounted therein. The holder 48 further includes a base 68 adapted to be secured (e.g., welded) to the drum, and a shield 66 that extends from the base 68 of the holder 48 to cover a portion of the holding sleeve 64. The shield 66 can be referred to as a wear protector to help eliminate exposure of the holding sleeve 64 to impacts and abrasive action. The shield 66 defines a protected pocket 70 at the inner end 60 of the holding sleeve 64 that can help to protect the end of the shaft 56 of the reducing element 40 as well as a reducing element retention clip 100 (also see FIG. 4) from harsh environments associated with material reducing applications.

The reducing element retention clip 100 is configured to fit within the circumferential groove 58 of the reducing element 40 to secure the reducing element 40 within the holding sleeve 64. The reducing element retention clip 100 helps to secure the reducing element 40 within the holder 48 by preventing the reducing element 40 from sliding out of the holding sleeve 64. When mounted in the groove 58 as shown at FIG. 3, the reducing element retention clip 100 abuts against the inner end 60 of the holding sleeve 64 to prevent the reducing element 40 from being unintentionally withdrawn from the holding sleeve 64. The reducing element 40 is rotatable within the holding sleeve 64 to allow the leading tip 44 to be evenly worn during operation. The reducing element retention clip 100 can rotate with the reducing element 40 relative to the sleeve 64. The reducing element retention clip 100 is illustrated and described in more detail with reference to FIG. 4.

Referring to FIG. 4, a perspective view of the reducing element retention clip 100 is depicted. In an example, a length L1 of the reducing element retention clip 100 can be about 3.28 inches. It is to be understood that the length L1 of the reducing element retention clip 100 may vary with other embodiments. In an example, a thickness T2 of the reducing element retention clip 100 can be about 0.177 inches. In other embodiment, the thickness T2 of the reducing element retention clip 100 may vary. The reducing element retention clip 100 may be made of a metal (e.g., steel) or other material with elastic characteristics. The reducing element retention clip 100 has a pair of legs 102 and a handle 104. In this example, the pair of legs 102 and the handle 104 are integrated together to form a unitary clip.

Each of the legs 102 has elastic characteristics that allow the pair of legs 102 to be flexible about flex points 106. The reducing element retention clip 100 includes a tapered lead-in portion 108, a shaft retention portion 110, and a shaft retention area 112 defined by the pair of legs 102. The reducing element retention clip 100 also includes a first and a second restriction 114, 116. The first restriction 114 is located between the tapered lead-in portion 108 and the shaft retention area 112. The second restriction 116 is located between the shaft retention area 112 and the handle 104.

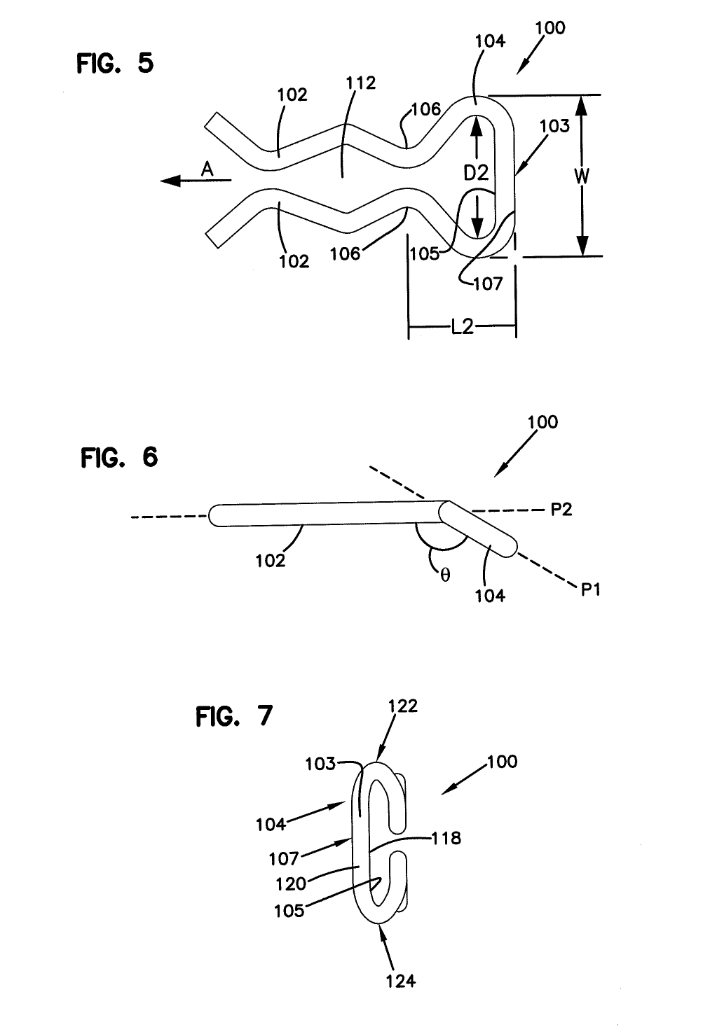

At the tapered lead-in portions 108, the legs 102 can be angled relative to one another. As shown in FIG. 5, at the tapered lead-in portions 108, the legs 102 may be angled to diverge from one another as they extend in an insertion direction A (i.e., a direction away from the handle 104). The reducing element retention clip 100 may be pushed by hand in the direction A for insertion into the circumferential groove 58 of the holder 48. The tapered lead-in portions 108 of the legs 102 may contact the surface of the reducing element 40 when inserting the reducing element retention clip 100 onto the reducing element 40. During insertion, the tapered lead-in portions 108 of the legs 102 engage the reducing element 40 at the circumferential groove 58, causing the legs 102 to flex away from one another about flex points 106. The reducing element retention clip 100 can be inserted in the direction A until the legs separate enough to allow the shaft 56 to move past the first restriction 114 and into the shaft retention area 112. After the shaft 56 moves past the first restriction 112, the legs 102 snap back into their original position due to the elastic characteristics of the reducing element retention clip 100. The first restriction 114 helps retain the reducing element 40 within the retention area 112 when the legs 102 return to their unflexed positions. Tools are not needed for inserting the reducing element retention clip 100 into the circumferential groove 58, which may help to reduce the replacement time of the reducing elements 40 in and out of mounting structures.

The shaft retention portion 110 of each of the pair of legs 102 defines the shaft retention area 112. As shown in FIG. 5, the shaft retention portion 110 is located between the first and second restrictions 114, 116. The shaft retention area 112 receives the shaft 56 of the reducing element 40. The shaft retention portion 110 rests within the circumferential groove 58 and secures the reducing element 40 to the holder 48. The second restriction 116 can help to prevent the shaft 56 of the reducing element 40 from moving into the handle 104 of the reducing element retention clip 100.

Still referring to FIG. 5, a width W of the handle 104 can be larger than any other portion of the reducing element retention clip 100. In one example, the handle 104 can be at least 10% wider than any other portion of the reducing element retention clip 100. In accordance with another aspect of the disclosure, the handle 104 may have a cross dimension D2 (i.e., an interior width) that is larger than the first or second restriction dimensions. The handle 104 can be constructed to have a cross-dimension D2 of between about 1.25 inches to about 1.75 inches. In various embodiments, the cross dimension D2 may be at least 1 inch, at least 1.25 inches, or at least 1.5 inches. In one example, the handle 104 has a cross-dimension of about 1.65 inches.

Referring to FIG. 6, the pair of legs 102 may extend from the handle 104 such that the handle aligns along a first plane P1 and the pair of legs 102 align along a second plane P2. The handle 104 has an angle θ relative to the pair of legs 102. In one example, the angle θ between the first plane P1 of the handle 104 and the second plane P2 of the pair of legs 102 is greater than 10 degrees. In some embodiments, the angle θ defined between the first and second planes P1, P2 can be between 20 and 40 degrees. In the depicted example, the angle θ between the first plane P1 and the second plane P2 is about 30 degrees. In one example, the handle 104 can have a length L2 (FIG. 5) of about 0.75 inches measured from the flat end 120 of the handle 104 to the second restriction 116. It is to be understood that the length L2 of the handle 104 may vary with other embodiments.

As shown in FIG. 7, the handle 104 of the reducing element retention clip 100 defines an opening 118. An operator may grasp the reducing element retention clip 100 within the opening 118. The opening 118 can be adapted to receive the fingers of the operator. The handle 104 may also be referred to as a finger loop. The handle 104 has a flat end 120 that provides a surface area for manually pushing the reducing element retention clip 100 into the circumferential groove 58 at the holder 48 after installation of the reducing element 40. The flat end 120 extends in a generally horizontal direction to meet curved portions 122, 124. The curved portions 122, 124 help to create space for the operator to place at least two fingers in the handle 104 of the reducing element retention clip 100. The operator can easily place two fingers in the handle 104 of the reducing element retention clip 100 to pull out the reducer element retention clip 100 by hand.

The handle 104 can have a straight end section 103 that has a length that extends along the cross-dimension D2 (FIG. 5). An inner portion 105 of the straight end section 103 can be engaged by the fingers (e.g., two fingers) of a technician to pull the reducing element retention clip 100 from the shaft 56 of the reducing element 40. An outer portion 107 of the straight end section 103 can be pushed by the technician to push the reducing element retention clip 100 onto the shaft 56 of the reducing element 40.

From the forgoing detailed description, it will be evident that modifications and variations can be made without departing from the spirit and scope of the disclosure.

What is claimed is:

1. An apparatus comprising:
a reducing element having a shaft and a circumferential groove;
a holder that receives the shaft of the reducing element;
a reducing element retention clip that mounts at the circumferential groove to retain the reducing element within the holder, the reducing element retention clip including:
a handle;
two flexible legs extending from the handle, the two flexible legs being configured to flex apart to receive the shaft of the reducing element, wherein the handle aligns along a first plane, wherein the two flexible legs align along a second plane, and wherein the first and second planes are angled relative to one another.

2. The apparatus of claim 1, wherein the holder includes a holding sleeve having an inner end and an outer end.

3. The apparatus of claim 2, wherein the reducing element further comprises a shoulder, the shoulder of the reducing element abuts against the outer end of the holding sleeve when the reducing element is mounted in the holder.

4. The apparatus of claim 3, wherein the shaft of the reducing element extends beyond the inner end of the holding sleeve such that the circumferential groove of the reducing element is accessible.

5. The apparatus of claim 2, wherein the holder includes a base adapted to be secured to a cutting element, and a shield that extends from the base to cover a portion of the holding sleeve.

6. The apparatus of claim 5, wherein the shield defines a pocket at the inner end of the holding sleeve for accessing the reducing element retention clip.

7. The apparatus of claim 5, wherein the cutting element is a rotary drum.

8. The apparatus of claim 1, wherein the apparatus is an excavating machine.

9. The apparatus of claim 1, wherein the apparatus is a surface mining machine.

10. A reducing element retention clip comprising:
a handle; and
two flexible legs extending from the handle, the two flexible legs being configured to flex apart to receive a shaft of the reducing element;
wherein the handle aligns along a first plane, wherein the two flexible legs align along a second plane, and wherein the first and second planes are angled relative to one another.

11. The reducing element retention clip of claim 10, wherein the angle defined between the first and second planes is greater than 10°.

12. The reducing element retention clip of claim 10, wherein the angle defined between the first and second planes is between 20° and 40°.

13. The reducing element retention clip of claim 10, wherein the two flexible legs define a shaft retention area positioned between first and second restrictions of the clip.

14. The reducing element retention clip of claim 10, wherein the two flexible legs are unitary with the handle, and wherein the handle forms a finger loop.

15. A reducing element retention clip comprising:
a flexible clip-defining member shaped to form a handle and a pair of legs that extend from the handle, the handle having a straight end section defining a cross-dimension of at least 1.25 inches, the pair of legs being integral with the handle and being configured to flex apart to receive a shaft of the reducing element between the legs.

16. The reducing element retention clip of claim 14, wherein the cross-dimension of the handle is at least 1.5 inches.

17. The reducing element retention clip of claim 15, wherein the handle is aligned along a first plane and the pair of legs are aligned along a second plane that is angled relative to the first plane.

18. A reducing element retention clip comprising:
a handle, the handle having a finger loop that defines an opening having a width of at least 1.25 inches; and
a pair of legs extending from the handle, the pair of legs defining:
a tapered lead-in portion; and
a shaft retention portion positioned between the handle and the tapered lead-in portion, the shaft retention portion including a shaft retention area positioned between two restrictions defined by the clip, wherein the first restriction is located between the tapered lead-in portion and the shaft retention area and the second restriction is located between the shaft retention area and the handle.

19. The reducing element retention clip of claim 18, wherein the handle defines a widest part of the reducing element retention clip.

20. The reducing element retention clip of claim 18, wherein the handle and the pair of legs are monolithically formed.

21. The reducing element retention clip of claim 18, wherein the handle includes a straight section defining an end of the reducing element retention clip.

22. An excavating machine including:
a cutting tool; and
reducing elements releasably secured to the cutting tool by the reducing element retention clips of any of claims 1-21.

23. The excavating machine of claim 22, wherein the cutting tool is a rotary drum.

24. The excavating machine of claim 23, wherein the excavating machine is a surface mining machine.
